(19) United States
(12) Patent Application Publication
(10) Pub. No.: US 2009/0260827 A1
(43) Pub. Date: Oct. 22, 2009

(54) Enzyme enhanced oil recovery (EEOR) for water alternating gas (WAG) systems

(76) Inventor: John L. Gray, Houston, TX (US)

Correspondence Address: GUERRY LEONARD GRUNE, 784 S VILLIER CT., VIRGINIA BEACH, VA, 23452, US

(21) Appl. No.: 12/456,956

(22) Filed: Jun. 25, 2009

Related U.S. Application Data
(63) Continuation of application No. 11/641,991, filed on Dec. 19, 2006, now abandoned.

(51) Int. Cl. E21B 43/16; C09K 8/60; E21B 43/00

(52) U.S. Cl. 166/305.1; 507/201; 166/105

(57) ABSTRACT

The present disclosure relates to the release or recovery of subterranean hydrocarbon deposits and, more specifically, to a system and method for enhanced oil recovery (EOR), by utilizing enzyme compositions and water-alternating-gas (WAG) methods for injecting water compositions, followed by miscible, near miscible or immiscible gas into subterranean formations for oil recovery operations.

### FIELD OF INVENTION

The present disclosure relates to the release or recovery of subterranean hydrocarbon deposits and, more specifically, to a system for enhanced oil recovery (EOR), by utilizing enzyme compositions and water-alternating-gas (WAG) methods for injecting enzyme fluid solutions followed alternatingly, with gas injection into subterranean formations.

### BACKGROUND OF INVENTION

It is a common practice to treat production wells and other subterranean formations with various methodologies in order to increase petroleum, gas, oil or other hydrocarbon production using enhanced (secondary or tertiary) oil recovery. Enhanced oil recovery processes include Water-Alternating-Gas (WAG), cyclic steam, steamflood, in-situ combustion, the addition of micellar-polymer flooding, and microbial solutions.

### Definitions

One common practice regarding enhanced oil recovery is to treat viscous crude in subterranean formations using cyclic steam to increase overall recovery of original oil in place (OOIP) in wells or hydrocarbon zones that otherwise have low recovery rates. A cyclic steam-injection process includes three stages. The first stage is injection, during which a slug of steam is introduced into the reservoir. The second stage, or soak period, requires that the well be shut in for several days to allow uniform heat distribution to thin the oil. Finally, during the third stage, the thinned oil is produced through the same well. The cycle is repeated as long as oil production is profitable.

Cyclic steam injection is used extensively in heavy-oil reservoirs, tar sands, and in some cases to improve infectivity prior to steamflood or in-situ combustion operations.

Cyclic steam injection is also called steam soak or the huff ‘n’ puff (slang) method.

Steamflooding is another method of thermal recovery in which steam generated at the surface is injected into the reservoir through specially distributed injection wells.

When steam enters the reservoir, it heats up the crude oil and reduces its viscosity. The heat also distills light components of the crude oil, which condense in the oil bank ahead of the steam front, further reducing the oil viscosity. The hot water that condenses from the steam and the steam itself generate an artificial drive that sweeps oil toward producing wells.

Another contributing factor that enhances oil production during steam injection is related to near-wellbore cleanup. In this case, steam reduces the interfacial tension that ties paraffins and asphaltenes to the rock surfaces while steam distillation of crude oil light ends creates a small solvent bank that can miscibly remove trapped oil.

Steamflooding is also known as continuous steam injection or steam drive.

In-situ combustion is a method of thermal recovery in which fire is generated inside the reservoir by injecting a gas containing oxygen, such as air. A special heater in the well ignites the oil in the reservoir and starts a fire.

The heat generated by burning the heavy hydrocarbons in place produces hydrocarbon cracking, vaporization of light hydrocarbons and reservoir water in addition to the deposition of heavier hydrocarbons known as coke. As the fire moves, the burning front pushes ahead a mixture of hot combustion gases, steam and hot water, which in turn reduces oil viscosity and displaces oil toward production wells.

Additionally, the light hydrocarbons and the steam move ahead of the burning front, condensing into liquids, which adds the advantages of miscible displacement and hot waterflooding.

In-situ combustion is also known as fire flooding or fireflood.

Other types of in-situ combustion are dry combustion, dry forward combustion, reverse combustion and wet combustion which is a combination of forward combustion and waterflooding.

Micelles are a group of round hydrocarbon chains formed when the surfactant concentration in an aqueous solution reaches a critical point. The micellar costs depend upon the cost of oil, since many of these chemicals are petroleum sulfonates.

Micellar-polymer flooding is an enhanced oil recovery technique in which a micelle solution is pumped into a reservoir through specially distributed injection wells. The chemical solution reduces the interfacial and capillary forces between oil and water and triggers an increase in oil production.

The procedure of a micellar-polymer flooding includes a preflush (low-salinity water), a chemical solution (micellar or alkaline), a mobility buffer and, finally, a driving fluid (water), which displaces the chemicals and the resulting oil bank to production wells.

The previously defined methods for enhanced oil recovery (EOR) all still leave residual hydrocarbons in the well. In some EOR, processes are combined to compensate for inefficiencies in one of more of the methods. In California, the injected steam volume is of the order of 10,000 barrels per cycle injected over about 2 weeks. In Cold Lake, Alberta, with oil viscosities that are 10-20 times higher than California, steam injection volumes are larger—perhaps 30,000 barrels per cycle injected over a month.

Hydraulic fracturing is accomplished by injecting a hydraulic fracturing fluid into the well and imposing sufficient pressure on the fracture fluid to cause formation breakdown with the attendant production of one or more fractures. Usually a gel, an emulsion or foam, having a proppant, such as sand or other suspended particulate material, is introduced into the fracture. The proppant is deposited in the fracture and functions to hold the fracture open after the pressure is released and fracturing fluid is withdrawn back into the well. The fracturing fluid has a sufficiently high viscosity to penetrate into the formation and to retain the proppant in suspension or at least to reduce the tendency of the proppant of settling out of the fracturing fluid. Generally, a gelation agent and/or an emulsifier is used in the fracturing fluid to provide the high viscosity needed to achieve maximum benefits from the fracturing process.

After the high viscosity fracturing fluid has been pumped into the formation and the fracturing has been completed, it is, of course, desirable to remove the fluid from the formation to allow hydrocarbon production through the new fractures. The removal of the highly viscous fracturing fluid is achieved by “breaking” the gel or emulsion or by converting the fracturing fluid into a low viscosity fluid. The act of breaking a gelled or emulsified fracturing fluid has commonly been obtained by adding a “breaker”, that is, a viscosity-reducing agent, to the subterranean formation at the desired time. This technique can be unreliable sometimes resulting in incomplete breaking of the fluid and/or premature breaking of the fluid before the process is complete reducing the potential amount of hydrocarbon recovery. Further, it is known in the art that most fracturing fluids will “break” if given enough time and sufficient temperature and pressure.

Several proposed methods for the breaking of fracturing fluids are aimed at eliminating the above problems such as introducing an encapsulated percarbonate, perchlorate, or persulfate breaker into a subterranean formation being treated with the fracturing fluid. Various chemical agents such as oxidants, i.e., perchlorates, percarbonates and persulfates not only degrade the polymers of interest but also oxidize tubulars, equipment, etc. that they come into contact with, including the formation itself. In addition, oxidants also interact with resin coated proppants and, at higher temperatures, they interact with gel stabilizers used to stabilize the fracturing fluids which tend to be antioxidants. Also, the use of oxidants as breakers is disadvantageous from the point of view that the oxidants are not selective in degrading a particular polymer. In addition, chemical breakers are consumed stoichiometrically resulting in inconsistent gel breaking and some residual viscosity which causes formation damage.

Water-alternating-gas is an enhanced oil recovery process whereby water injection and gas injection are alternately injected for periods of time to provide better sweep efficiency and reduce gas channeling from the injector to the producer. This process is used primarily in miscible or immiscible CO₂ floods to improve hydrocarbon contact time and the sweep efficiency of the CO₂. This process is used to maintain or improve existing production while increasing the amount of original oil in place (OOIP) that is recovered beyond primary and secondary recovery methods. Other oxidized gases have also been shown to help increase oil yields.

The use of enzymes to break fracturing fluids may eliminate some of the problems relating to the use of gaseous oxidants. For example, enzyme breakers have been found to be very selective in degrading specific oxygen containing polymers such as partially hydrolyzed polyacrylamides, carboxylmethyl cellulose, or polyethylene oxide. The enzymes do not effect the tubulars, equipment, etc. that they come in contact with and/or damage the formation itself. The enzymes also do not interact with the resin coated proppants commonly used in fracturing systems. Enzymes react catalytically such that one molecule of enzyme may hydrolyze up to one hundred thousand (100,000) polymer chain bonds resulting in a cleaner more consistent break and very low residual viscosity. Consequently, formation damage is greatly decreased. Also, unlike oxidants, enzymes do not interact with gel stabilizers used to stabilize the fracturing fluids.

It has been discussed previously that there are several methods of recovering oil from individual wells or groups of wells, however, no art is disclosed that indicates an enzyme has been used as an additive for water-alternating-gas (WAG) injection in tertiary oil recovery.

Therefore, there exists a need for a method of injecting an enzyme composition used in conjunction with water-alternating-gas (WAG) injection that improves water's ability to recover additional oil, has a wide temperature range for activity, and is non-reactive with miscible or immiscible gases being injected. The disclosure provides several methods for injecting an enzyme composition as an additive in the water phase for WAG treatments of hydrocarbon deposits, that is not a breaker for the dissolution of polymeric viscosifiers, but improves injectivity and oil recovery through its catalytic ability to release oil from solid surfaces while, at the same time, reducing surface tension and decreasing contact angle associated with the crude oil flow.

### DESCRIPTION OF PRIOR ART

U.S. Pat. No. 5,267,615, to Christiansen, et. al., and unassigned, describes a process for recovering oil from a porous gas cap of a subterranean hydrocarbon-bearing formation comprising placing a volume of an oil-immiscible water in a gas cap to mobilize and displace heretofore substantially immobile oil residing therein then injecting a volume of an oil-immiscible non-aqueous gas into the gas cap to drive the mobilized oil from the gas cap. The ratio of volume of oil-immiscible water to the volume of the non-aqueous gas is no greater than about 1:10 and further the first two steps constitute an injection cycle and recovery of the oil which is mobilized from the gas cap by the oil-immiscible water and driven from the gas cap by the oil-immiscible non-aqueous gas during the injection cycle. All the while substantially retaining the oil-immiscible water in the gas cap.

U.S. Pat. No. 4,813,484, to Hazlitt, Randy, and assigned to Mobil Oil Corp., describes a method for producing hydrocarbonaceous fluids from a subterranean formation comprising injecting an aqueous slug into a formation which fluid contains; water, a surfactant, and a decomposable chemical blowing agent. The chemical blowing agent then decomposes in-situ thereby generating gas in an amount and rate sufficient to form foam with the surfactant, foaming the aqueous slug and then injecting a drive fluid thereby displacing hydrocarbonaceous fluids from the formation.

U.S. Pat. No. 4,846,276, to Haines, Hiemi, and assigned to Marathon Oil Co., describes an oil recovery process for recovering a low viscosity crude oil from an oil-bearing zone of a subterranean formation comprising, injecting a gas into an oil-bearing zone of a subterranean formation via an injection well in fluid communication with the oilbearing zone, with the gas injected at an injection pressure substantially below the minimum miscibility pressure of the gas into low-viscosity crude oil. Secondly, displacing the low-viscosity crude oil away from the injection well toward an oil production well in fluid communication with the oil-bearing formation and continuously recovering the low-viscosity crude oil from the oil production well. The injection of the gas is terminated upon substantial diminution of continuous crude oil recovery from the production well and water is then injected into the oil-bearing zone of the formation via the injection well whereby low-viscosity crude oil is displaced away from the injection well toward the oil production well where recovering the low-viscosity oil from the oil production well takes place and water injection is terminated.

U.S. Pat. No. 5,634,520, to Stevens, et. al., and assigned to Chevron, USA, describes a process for the enhanced recovery of oil from an oil-bearing reservoir formation comprising injecting effective oil producing amounts of a non-condensable gas and an aqueous drive fluid simultaneously into the formation, characterized in that the gas and aqueous drive fluid begins from an initial preselected water to gas ratio and increases to a ratio of 2:1 to 3:1 and wherein the amount of the gas injected is effective to reduce the viscosity of the oil or to increase its mobility through the reservoir formation.

U.S. Pat. No. 5,515,919, to Stevens, et. al., and assigned to Chevron, USA, describes a process for the enhanced recovery of oil from an oil-bearing reservoir formation comprising at least periodically sequentially injecting effective oil producing amounts of a non-condensable gas and an aqueous drive fluid into the formation characterized in that the gas and aqueous drive fluid are injected at a preselected water to gas ratio and the amount of gas injected prior to switching to injection of aqueous drive fluid as measured in hydrocarbon pore volume, is less than 0.25% wherein the amount of the gas injected is effective to reduce the viscosity of the oil or to increase its mobility through the reservoir formation.

U.S. Pat. No. 4,860,828, to Oswald, et. al., and assigned to The Dow Chemical Co., describes a method for recovering hydrocarbons from a subterranean formation comprising injecting, under non-steam flood conditions, into the subterranean formation through an injection well, a first fluid selected from group consisting essentially of a drive fluid of a gas or a gas/aqueous fluid mixture and a miscible fluid to move the hydrocarbon from the formation to a producing well and a second fluid which is a mobility control fluid comprising a surfactant/water mixture wherein the surfactant component of the mobility control fluid consists essentially of a mixture of at least one alkylated diphenyl sulfonate and at least one alpha-olefin sulfonate.

U.S. Pat. No. 5,711,373, to Lange, Elaine, and assigned to Exxon Production Research Co., describes a method for predetermining the amount of a hydrocarbon liquid remaining in a subterranean formation resulting from introducing a substantially non-aqueous displacement fluid into the formation and producing at least a portion of the hydrocarbon liquid. The method comprises determining a solubility parameter for the hydrocarbon liquid in the formation before introducing the displacement fluid into the formation, determining a solubility parameter for the displacement fluid before introducing it into the formation, determining the difference between the hydrocarbon liquid and displacement fluid solubility parameters, predetermining, from the difference, the amount of hydrocarbon liquid that should remain in the formation resulting from introducing the displacement fluid into the formation, introducing a substantially non-aqueous displacement fluid into the formation and producing at least a portion of the hydrocarbon liquid.

U.S. Pat. No. 5,465,790, to McClure, et. al., and assigned to Marathon Oil Co., describes a process for enhanced recovery of hydrocarbons from a subterranean formation, penetrated by at least one injection well and at least one production well in fluid communication with the formation, the formation having heterogeneous permeability with an aqueous fluid present in the higher permeability layers and oil present in the lower permeability layers. The process steps comprise; injecting an aqueous surfactant solution into the formation via the at least one injection well with the surfactant solution having a surfactant dissolved therein in an amount effective to imbibe into and create an interface tension gradient within the lower permeability layers. The interface tension gradient causes displacement of a first quantity of oil from the lower permeability layers into the higher permeability layers and injecting a first aqueous fluid into the formation via the at least one injection well sweeping at least a portion of the first quantity of oil from the higher permeability layers to the at least one production well. A gas is then injected into the formation via the at least one injection well with a portion of the gas entering the lower permeability layers by gravity segregation displacing a second quantity of oil from the lower permeability layers to the higher permeability layers. A second aqueous fluid is then injected into the formation via the at least one injection well thereby sweeping at least a portion of the second quantity of oil from the higher permeability layers to the at least one production well and portions of the first and second quantities of oil are recovered from the at least one production well.

U.S. Pat. No. 5,363,915, to Marquis, et. al., and assigned to Chevron, USA, describes a method of enhancing recovery of petroleum from an oil bearing formation during injection of non-condensable gas comprising at least periodically injecting a foam into the oil bearing formation where the foam comprises a mixture of a gas phase consisting essentially of non-condensable gas and a water phase containing an effective amount of at least one non-ionic surfactant having an HLB value of about 14 to less than 20 and which is selected from among ethoxylated alkyl phenols; ethoxylated linear secondary alcohols; propoxylated, ethoxlated primary alcohols and mixtures thereof.

U.S. Pat. No. 5,363,914, to Teletzke, Gary, and assigned to Exxon Production Research Co., describes a method for recovering oil from a subterranean oil-containing formation comprising sequentially injecting into the formation through an injection well in communication therewith a slug of an aqueous solution containing a high concentration of a gas mobility control agent. The slug is of sufficient size to satisfy retention of the agent within pore spaces contacted by the high concentration solution followed by a slug of an aqueous solution containing a low concentration of a gas mobility control agent. The gas as the primary oil displacing fluid, is selected from the group consisting of carbon dioxide, hydrocarbon gas, inert gas and steam whereby the gas and said slugs of aqueous solution containing the gas mobility control agent form a mixture in the formation that significantly reduces gas mobility in more permeable regions of the formation wherein oil is recovered at a spaced apart producing well.

U.S. Pat. No. 5,358,045, to Sevigny, et. al., and assigned to Chevron, USA., describes a method of recovering hydrocarbons from a reservoir during gas injection into a reservoir comprising at least periodically injecting gas and a foam-forming composition into a reservoir wherein the reservoir temperature is not less than about 100° F. The foam-forming composition comprises brine having not less than about 10% TDS, an effective foam-forming amount of a surfactant comprising a C10-16 AOS having a major amount of at least one of C10 AOS and C12 AOS, and an effective amount of at least one solubilizing component to increase the brine tolerance of the foam-forming composition, which solubilizing component is a mixture comprising a formulation where M is H, an alkali metal, alkaline earth metal, or ammonium, and R1 is a linear C6-C16 alkyl group and contacting hydrocarbons in the reservoir with the foam and the gas so as to assist in the recovery of hydrocarbons from the reservoir.

U.S. Pat. No. 5,203,411, to Dawe, et. al., and assigned to The Dow Chemical Co., describes a method for recovering hydrocarbons from a subterranean formation which comprises injecting, sequentially or simultaneously, into the subterranean formation containing hydrocarbons; a drive fluid selected from the group consisting of a gas to drive the hydrocarbons, a gas/aqueous fluid mixture to drive the hydrocarbons, a miscible fluid to thin or solubilize and carry the hydrocarbons, and a miscible fluid/aqueous fluid mixture to thin or solubilize and carry the hydrocarbons from the formation to a producing well. Additionally injected is a mobility control fluid of a surfactant/aqueous fluid mixture comprising a mixture of one or more alkylated diphenyl sulfonate surfactants and one or more foam forming amphoteric surfactants under conditions such that the hydrocarbon is recovered from the subterranean formation.

U.S. Pat. No. 5,134,176, to Shu, Paul, and assigned to Mobil Oil Corp., describes an aqueous crosslinked copolymeric gel-forming composition comprising; (a) water, (b) a water-dispersible polyvinyl amine copolymer where the polyvinyl amine copolymer is a copolymer of vinylamine and vinylamide having a structure wherein R is an alkyl or aryl group having up to 10 carbon atoms and (a) and (b) are mole fractions of each co-monomer unit such that a+b=1, and a is not equal to 0 and b is not equal to 0 and a crosslinking agent which is selected from the group consisting of phenolic resins and mixtures of a phenolic component and an aldehyde wherein the crosslinking agent is present in an amount effective to cause gelation of an aqueous solution of the polyvinyl amine copolymer.

U.S. Pat. No. 5,076,357, to Marquis, David, and assigned to Chevron, USA, describes a method of enhancing recovery of petroleum from an oil bearing formation during injection of a non-condensable gas comprising at least periodically injecting a preformed foam into the oil bearing formation. The preformed foam comprises a mixture of gas, water and an effective foam-forming amount of an alpha olefin sulfonate (AOS), with the AOS comprising a mixture of hydroxysulfonates and alkene-sulfonates and further wherein the hydroxy-sulfonates comprise 3-hydroxy- and 4-hydroxy-sulfonates with the ratio of 3-hydroxy-sulfonates to 4-hydroxy-sulfonates being at least about 3.

U.S. Pat. No. 4,940,090, to Hoskin, et. al., and assigned to Mobil Oil Corp., describes a process for recovering oil from a subterranean oil-bearing formation having relatively high permeability zones and relatively low permeability zones penetrated by at least one production well in fluid communication with a substantial portion of the formation, comprising the steps of (a) injecting into the formation an aqueous gel-forming composition comprising water and a water-dispersible polyvinyl alcohol copolymer with the polyvinyl alcohol copolymer selected from the group consisting of copolymers of vinyl alcohol and vinyl alkyl sulfonate ether having a specific structure and copolymers of vinyl alcohol and vinyl-acrylamido ether, having the structure wherein R is an alkyl or aryl group having up to 10 carbon atoms; M+ is Na+, K+ or other counter ions and a and b are mole fractions of each co-monomer unit such that a+b=1, and a>o and b>o and a crosslinking agent which is a mixture of a phenolic component and an aldehyde. The crosslinking agent is present in an amount effective to cause gelation of the polyvinyl copolymer and is injected as a flooding fluid into the formation that preferentially enters the low permeability zones and the fluids, including oil from the formation, are recovered via the production well.

U.S. Pat. No. 4,828,029, to Irani, Cyrus, and unassigned, describes an improved method for recovering oil from a subterranean, hydrocarbon-bearing formation which is penetrated by at least one injection well and at least one production well wherein a liquid non-aqueous displacement fluid is injected into a formation through an injection well and fluids are produced from the production well with the improvement comprising dissolving in the non-aqueous displacement fluid an effective amount of a surfactant and a cosolvent prior to injecting the fluid into the formation. The cosolvent is adapted to increase the solubility of the surfactant in the displacement fluid. The displacement fluid is selected from the group comprising carbon dioxide, nitrogen, and mixtures of any combination selected from the group comprising carbon dioxide, nitrogen, and light hydrocarbons.

U.S. Pat. No. 4,676,316, to Mitchell, Thomas, and assigned to Mobil Oil Corp., describes a method for improved enhanced recovery of oil from a subterranean hydrocarbon-bearing reservoir by water-alternating-gas flooding, the improvement which comprises effecting simultaneous mobility and profile control by injecting into the reservoir an aqueous solution of a water-soluble polymer in combination with a stable foam-forming surfactant in an amount of from about 0.05% to 2.0% of the aqueous solution, and injecting into the reservoir a gas under pressure sufficient to effect mobility of hydrocarbon deposits and continuously recovering oil at a producing well of the reservoir.

U.S. Pat. No. 3,529,668, to Bernard, George, and assigned to Union Oil Co., describes a Drive fluid, gas with a liquid injected into a well to displace the oil in a well whereas the ratio of gas to liquid is between 5 to 15 as measures at well conditions regarding temperature and pressure.

U.S. Pat. No. 3,779,315, to Boneau, David, and assigned to Phillips Petroleum Co., describes a method for producing hydrocarbons from a subterranean hydrocarbon-containing formation penetrated by at least a first well bore and reducing the flow of gas into the well bore from a gas cap positioned in the upper portion of the formation, comprising: passing a preselected volume of polymeric solution into the hydrocarbon-containing formation at a location lower in elevation than the gas cap; terminating the injection of the polymeric solution and producing fluids entering the well bore while at least intermittently injecting one of a gas-water admixture, or volumes of gas and water into said gas cap of said hydrocarbon-containing formation. The polymer of the polymeric solution is one of partially hydrolyzed polyacrylamides, carboxylmethyl cellulose, or polyethylene oxide.

U.S. Pat. No. 3,788,398, to Shepard, Cecil, and assigned to Mobil Oil Corp., describes a method of producing oil from a subterranean reservoir having an oil zone and a gas cap, with the gas cap being penetrated by an injection system and the oil zone being penetrated by a production system. The production system comprises the steps of (a) injecting via the injection system into the gas cap a fluid that is miscible with the oil in the oil zone and the gas in the gas cap; (b) injecting gas via the injection system into the gas cap; (c) injecting via the injection system into the gas cap, water, in an amount less than the amount required to extend the water into the oil zone and (d) producing oil via the production system from the reservoir.

U.S. Pat. No. 4,856,589, to Kuhlman, et. al., and assigned to Shell Oil Co., describes a process for recovering oil from a reservoir, penetrated by at least one injection well and one production well comprising: formulating an aqueous surfactant solution such that the surfactant is present in the solution at a concentration less than its critical micelle concentration, injecting the surfactant solution into the reservoir and injecting a gas to displace the surfactant solution through the reservoir to assist in the recovery of hydrocarbons at the production well.

U.S. Pat. No. 5,678,632, to Moses, et. al., and assigned to Cleansorb Limited, describes a method of acidising an underground reservoir which comprises: injecting into the reservoir an isolated enzyme and a substrate for the enzyme, which substrate is capable of being converted into an organic acid by the enzyme and allowing the enzyme to catalyze the conversion of the substrate into the acid. The enzyme and substrate are injected into the well bore simultaneously.

U.S. Pat. No. 4,971,151, to Sheehy, Alan, and assigned to BWN Live-Oil Pty. Ltd., describes a method for recovering oil from a reservoir having a population of endogenous microorganisms comprising adding to the reservoir, nutrients comprising a non-glucose-containing carbon source and at least one other non-glucose-containing nutrient. The nutrient is growth effective for the endogenous microorganisms, maintaining the reservoir for a time and under conditions sufficient for the substantial depletion of at least one of the added nutrients wherein the added nutrients and depletion of at least one of the added nutrients results in microorganisms having reduced cell volume and increased surface active properties and thereafter subjecting the reservoir to oil recovery means.

U.S. Pat. No. 5,083,610, to Sheehy, Alan, and assigned to BWN Live-Oil Pty. Ltd., describes a method for recovering oil from a reservoir having a population of endogenous microorganisms comprising adding to the reservoir, nutrients, comprising a non-glucose-containing carbon source and at least one other non-glucose-containing nutrient. The nutrient is growth effective for the endogenous microorganisms maintaining the reservoir for a time and under conditions sufficient for the substantial depletion of at least one of the added nutrients wherein the added nutrients and depletion of at least one of the added nutrients result in microorganisms having reduced cell volume and thereafter subjecting the reservoir to oil recovery means.

WIPO Patent Publication No WO9635858A1, to Djabbarah, et. al., and assigned to Mobil Oil Corp., describes a steamflood method for producing oil from a subterranean, oil-containing formation by injecting steam into the formation and recovering oil from a production well, characterized in that a mixture of a noncondensable gas and an aqueous surfactant-polypeptide solution is injected into the formation through a well, to form a foam which reduces the permeability of swept zones, forcing injected steam into unswept areas of the formation.

WIPO Patent Publication No WO9304265A1, to Frazier, et. al., and assigned to Chevron, USA, describes a method for recovering hydrocarbons from a formation comprising at least periodically injecting a gas and a foam-forming composition into a formation so as to provide a foam, wherein the composition comprises water and effective foam-forming amounts of at least one cationic and at least one anionic surfactant. The ratio of the at least one anionic surfactant to the at least one cationic surfactant is selected such that the surfactants do not form substantial amounts of precipitate when mixed together; contacting the hydrocarbons in the formation with the foam and the gas so as to assist in the recovery of hydrocarbons.

WIPO Patent Publication No WO9014496A1, to Buller, et. al., and assigned to University of Kansas, describes a method for enhanced recovery of hydrocarbon fluids by the injection of a flooding fluid into a subterranean hydrocarbon fluid bearing formation through an injection well extending from the surface of the earth into the formation to displace in situ hydrocarbon fluids from the formation towards at least one production well spaced at a distance away from the injection well. The improvement comprises: (1) first injecting a quantity of acidic water into the formation through the injection well; (2) injecting a quantity of reversibly gelable, water insoluble, alkaline beta 1,3 polyglucan homopolymer solution, which solution gels immediately upon one of neutralization and acidification thereof, into the injection well; (3) injecting a drive fluid into the injection well and producing at least some hydrocarbon fluids from the production well.

European Patent Publication No EP0305612A1, to Holm, Leroy, and assigned to Union Oil Co., describes a method for reducing the permeability of higher permeability zones of an oil bearing subterranean reservoir having heterogeneous permeability and being penetrated by at least one well. The method comprises first injecting through a well and into the reservoir an aqueous liquid solution of a water soluble surface active agent and a foam emplacement gas mixture consisting essentially of carbon dioxide and a crude oil-insoluble, noncondensable, non-hydrocarbon gas wherein the injection is under conditions such that the gas mixture maintains a density between 0.01 and 0.42 grams per centimeter in the reservoir. Secondly, allowing stable foam to form in the higher permeability zones and diverting subsequently injected gases into lower permeability zones of the reservoir without destroying the stable foam producing oil from the reservoir.

### SUMMARY OF THE DISCLOSURE

One embodiment of the disclosure includes a method and system of removing petroleum, oil and other hydrocarbon deposits releasable by a substance from a subterranean formation below a surficial formation. The method and system according to this disclosure comprises, in combination, the steps of providing a hole through the surficial formation to the subterranean formation, injecting an enzyme fluid through the surficial formation to the subterranean formation, storing the substance at the surficial formation in the form of a liquid at the subterranean formation. Also, for injection, providing a fluid that is non-reactive with injections of miscible or immiscible gas and has temperature stability sufficient for a sustained liquid phase of the enzymatic fluid under pressure at the subterranean formation.

The ability to drive the liquid into the subterranean formation for releasing hydrocarbon deposits with that liquid moving from an injection well to one or more producing wells, and removing such released deposits from the subterranean formation using enzymatic fluids is part of the disclosure. Alternating the liquid injection cycle with an injection cycle of a miscible, near miscible or immiscible gas with the ability to drive the gas into the subterranean formation through an injection well for releasing hydrocarbon deposits with that gas, and removing released deposits thru one or more producing wells separate from the injection well from the subterranean formation in combination with the enzymatic fluid is also part of the present disclosure.

Another embodiment of the disclosure is a method and system for injecting an enzyme composition into a well as a treatment for enhanced oil recovery (EOR) within a water-alternating-gas process cycle sometimes referred to as WAG.

Another embodiment involves injecting miscible, near miscible or immiscible gas including natural gas, nitrogen, flue gas, CO2, hydrocarbon gas such as liquified petroleum gas (LPG), propane, butane and propane mixtures, methane enriched with other light hydrocarbons, and methane under high pressure into a wellbore.

Another embodiment is the enzyme composition is active in a diluted range of 0.01 to 100 percent and is suitable, but not limited to, a working range of 3 to 10 percent for injection with water. Injection of enzyme may have different points of addition and can occur along with large injections of water that are part of a designed WAG treatment or in concentrated or diluted enzyme fluids that are injected “on the fly” to water injection lines that actively pump water. Metered addition of enzyme to maximize efficient use of enzyme and optimize WAG performance is also possible.

Another embodiment includes the use of an enzyme composition in combination with water in a WAG treatment to extend the effective consumption of miscible or immiscible gas being injected thus improving overall capacity while offsetting or minimizing reduced recoverability normally associated with reduced use of gas injection. Some oil wells have formations that are suitable for straight gas injection where no WAG treatment is used. This also means a high rate of gas injection that may or may not be sustainable as demand for straight gas and WAG injection grows.

Another embodiment includes the use of an enzyme composition to be injected into a subsurface formation to improve the mobility of heavier crude oils going from the injection well to one or more producing wells and to prevent plugging in producing wellbores or restricted flow areas as well as plugging the pipelines.

Another embodiment is the use of an enzyme composition for penetrating asphaltenes and waxes at the injection wellbore prior to or during WAG injection as well as minimizing similar build up that can occur at one or more producing wellbores during production.

Another embodiment includes use of an enzyme in WAG operations such that the enzyme does not affect the normal function or react with the gas being injected in the surrounding well formations as it moves from an injection well to one or more producing wells.

### BRIEF DESCRIPTION OF THE DRAWINGS

FIG. 1 is a schematic WAG injection stages with a pretreatment stage using an enzyme composition.

### DETAILED DESCRIPTION

Disclosed is an improvement to water-alternating-gas (WAG) processes for tertiary oil recovery that utilizes an enzyme composition to increase the ability of the water phase to recover and mobilize oil. This water based fluid has a biological enzyme that is a protein based, non-living catalyst for penetrating and releasing oil from solid surfaces and demonstrates the following attributes:

The enzyme fluid has the effect of increasing the mobility of the oil by reducing surface tension, decreasing contact angles and preventing crude oil that has become less viscous by heating or other means, from re-adhering to itself as it cools.

The enzymatic fluid is active in water and acts catalytically in contacting and releasing oil from solid surfaces.

Enzymes are non-living and do not require nutrients or ingest oil.

Enzyme fluid does not grow or plug an oil formation or release cross-linked polymers.

Enzyme fluid does not trigger any other downhole mechanisms, except to release oil from the solid substrates. (ie: one function).

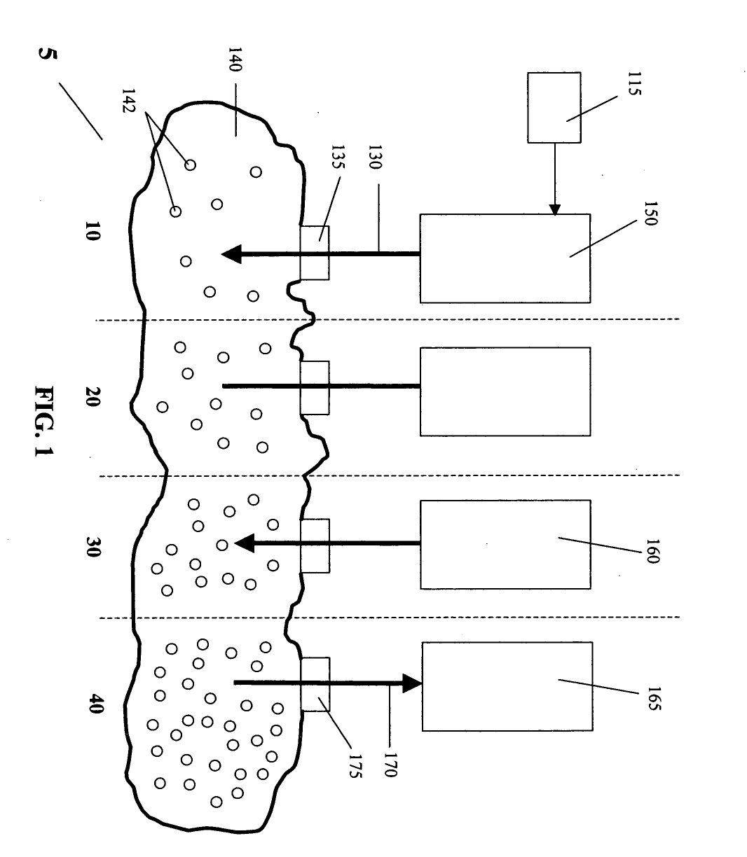

Referring to FIG. 1, in an overview, the water-alternating-gas (WAG) and enzyme system [4] is comprised of four (4) stages. The first stage includes a normal water composition injection stage [10] with at least one injection well, an alternative period of idle process known as the soak stage [20], followed by the gas injection stage [30] and then a recovery stage [40] of produced oil by one or more producing wells that are designed and configured to recovery oil from one or more injection wells. This water-alternating-gas (WAG) and enzyme system [5] is sequential and repeated based on the economics and availability of gas to inject, water availability, energy requirements to both produce oil and recover and re-inject the gas, and increased production and recovery rates achieved thru the combination of gas injection and enzyme addition. The water composition of the water composition injection stage [10] may include any substance known to those in the art.

During the water composition injection stage [10], enzymes [115], are added to water and flow to an injection pump [150] where it is then pumped down an injection pipe [130], through the downhole well bore [135] and into the oil well formation [140]. The water composition acts to release the oil from solid surfaces, increase the mobility of the oil by reducing surface tension, decreasing contact angles, preventing crude oil that has become less viscous by heating or other means, from re-adhering to itself as it cools and acts catalytically in contacting and releasing oil from solid surfaces. Blockages in the oil well formation [140] may be reduced or eliminated as well.

The enzymes [115] are pushed into the oil well formation [140] to further contact oil particles [142] thereby increasing contact volume.

The soak stage [20] as it is known, allows the water and enzyme [115] composition to permeate the oil well formation [140] and the enzymes[115] to reach maximum oil releasing efficiency. The enzymes [115] remains active in the water or hot water compositions and acts catalytically in contacting and releasing oil from solid surfaces. It is not restricted by variations in the American Petroleum Institute (API) specific gravity ratings of the crude oil. The soak stage [20] may last between 0-30 days depending on the type and size of the oil well formation [140] and spacing between the injection well and one or more producing wells. The soak stage [20] may be omitted when the gas injection stage [30] immediately follows the water composition injection stage [40].

Normally following the soak stage [20] is a gas injection stage [30] to which a gas injection pump [160] is connected to the oil well formation [140] via an injection pipe [130] and a wellbore [135]. Miscible, near miscible or immiscible gas flows into the gas injection pump [160] where it is under pressure and flows into the oil well formation [140] via an injection pipe [130] and a wellbore [135]. The gas then displaces the water composition and enzymes [115] pushing oil particles [142] toward the part of the oil well formation [140] where recovery operations occur.

Following the gas injection stage [30] is the recovery stage [40] in which one or more extraction pump [165] is connected to the oil well formation [140] via a retrieval pipe [170] and an uphole well bore [175]. In the recovery stage [40], the extraction pump [165] is activated causing the oil particles [142] to be transferred from the oil well formation [140] through the uphole well bore [175] and retrieval pipe [170] to be transferred for refining.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. An enzymatic fluid for enhanced recovery of oil or other hydrocarbon deposits in a subterranean formation, wherein said deposits are releasable by initially adding said enzymatic fluid directly to a pump for pumping said fluid, combined with water forming a water composition, into said oil formation through an injection well followed by an additional period of time allowing said fluid and said water composition to soak said formation by said composition moving from said injection well to one or more producing wells followed by injection of gas into said formation, followed by recovery of said deposits by pumping or other means.

2. The enzymatic fluid of claim 1, wherein said pumping of said fluid independently or as said water composition injection followed by soak time moving from injection well to one or more producing wells, followed by injection of gas and subsequent recovery of said deposits, is known as a water-alternating-gas (WAG) and enzyme system and may be sequential and repeated as required.

3. The enzymatic fluid of claim 1, wherein said water composition may contain any substance or combination of substances useful for enhanced oil recovery.

4. The enzymatic fluid of claim 1, wherein said gas is miscible, partially miscible, or fully immiscible with either said enzymatic fluid, said hydrocarbon deposits, and/or said subterranean formation.

5. The enzymatic fluid of claim 1, wherein said fluid is used for treatment of the subterranean formation during water injection wherein said enzymatic fluid is injected as a cold, heated or ambient liquid in any combination into said formation.

6. The enzymatic fluid of claim 1, wherein said fluid is diluted with water in a range of 0.01 to 99 percent and more specifically is diluted within a working range of 3 to 10 percent of enzymatic fluid in water.

7. The enzymatic fluid of claim 1, wherein said fluid is incrementally diluted to stimulate wells that are at an unacceptable level of production prior to restarting a water-alternating-gas (WAG) and enzyme injection process.

8. The enzymatic fluid of claim 1, wherein said fluid is used for pre-treatment or treatment of said formation during enhanced oil recovery such that said fluid is injected and intermixed with water which is sent into said formation and wherein said formation is a well that is subsequently not used for a period of time allowing for soaking of said well prior to another phase of enhanced oil recovery including, but not limited to pumping and use of water and gas for one or more cycles during said recovery.

9. The enzymatic fluid of claim 1, wherein said fluid reduces asphaltenes and waxes at an injection wellbore prior to injection as well as minimizing wellbore build up during production that occurs at an end of an enhanced oil recovery cycle, wherein said cycle includes a water-alternating-gas (WAG) and enzyme system.

10. A method for enhanced recovery of oil or other hydrocarbon deposits in a subterranean formation using an enzymatic fluid, wherein said deposits are releasable by initially independently adding said enzymatic fluid directly to a pump for pumping said fluid into said oil formation followed by a water composition injection, followed by an optional period of idle process time allowing said fluid and said water composition to soak said formation, followed by injection of gas into said formation, followed by recovery of said deposits by pumping or other means.

11. The method of claim 10, wherein adding said fluid after initial water-alternating-gas of said gas is accomplished.

12. The enzymatic fluid of claim 10, wherein said gas is miscible, partially miscible, or fully immiscible with either said enzymatic fluid, said hydrocarbon deposits, and/or said subterranean formation.

13. The method of claim 10, wherein the method for injecting said enzymatic fluid includes a process referred to as water-alternating-gas (WAG).

14. The method of claim 10, wherein using said fluid for pre-treatment on injection well or treatment of said subterranean formation during a water injection cycle wherein said enzymatic fluid is injected as cold, heated, or ambient liquid in any combination, into said formation, is accomplished.

15. The method of claim 10, wherein diluting said fluid with water in a range of 0.01 to 99 percent and more specifically diluting within a working range of 3 to 10 percent of enzymatic fluid in water prior to adding to the total injection water.

16. The method of claim 10, wherein said fluid is incrementally diluted to stimulate wells that are at an unacceptable level of production prior to restarting a WAG injection process.

17. The method of claim 10, wherein using said fluid for pre-treatment or treatment of said formation during enhanced oil recovery such that injecting said fluid and intermixing with water is accomplished and said fluid and water are sent into said formation and wherein said formation is a well that is subsequently not used for a period of time allowing for soaking of said well prior to another phase of enhanced oil recovery including, but not limited to pumping and using water for one or more cycles during said recovery.

18. The method of claim 10, wherein said fluid provides a means for reducing asphaltenes and waxes at an injection wellbore prior to injection as well as minimizing wellbore build up during production occurring at an end of an enhanced oil recovery cycle, wherein said cycle includes a WAG cycle.

19. A system for enhanced recovery of oil or other hydrocarbon deposits in a subterranean formation using an enzymatic fluid, said deposits are releasable by initially adding said enzymatic fluid directly to a pump for pumping said fluid, combined with water forming a water composition, into said oil formation through an injection well followed by an additional period of time allowing said fluid and said water composition to soak said formation by said composition moving from said injection well to one or more producing wells followed by injection of gas into said formation, followed by recovery of said deposits by pumping or other means.
